(19) United States
(12) Patent Application Publication
(10) Pub. No.: US 2015/0091803 A1
(43) Pub. Date: Apr. 2, 2015

(54) MULTI-TOUCH INPUT METHOD FOR TOUCH INPUT DEVICE

(71) Applicant: ASUSTeK COMPUTER INC., Taipei (TW)

(72) Inventors: Jung-Hsing Wang, Taipei (TW); Yu-Chen Lee, Taipei (TW); Hung-Yi Lin, Taipei (TW)

(21) Appl. No.: 14/487,721

(22) Filed: Sep. 16, 2014

(30) Foreign Application Priority Data
Sep. 27, 2013 (CN) 201310451350.5

(51) Int. Cl. G06F 3/0354

(52) U.S. Cl. CPC G06F 3/03543; G06F 3/03547; G06F 2203/04104
USPC 345/163

(57) ABSTRACT

A multi-touch input method of a touch input device is provided, it includes defining a first touch area and a second touch area on the touch input device; generating a first control command when a first touch event is provided; detecting whether a second touch event is provided at the second touch area while the first touch event is kept for a period and generating a second control command when the second touch event is provided; and executing a corresponding function.

### CROSS-REFERENCE TO RELATED APPLICATION

This application claims the priority benefit of Chinese (CN) Application Serial No. 201310451350.5, filed on Sep. 27, 2013. The entirety of the above-mentioned patent application is hereby incorporated by reference herein and made a part of specification.

### BACKGROUND OF THE INVENTION

1. Field of the Invention

The invention relates to a touch control method and, more particularly to a touch control method for a touch input device.

2. Description of the Related Art

Nowadays, various electronic products are equipped with touch input interfaces, such as a smart phone, a tablet computer and a notebook computer. Moreover, there are also some individual touch input devices such as a touch pad, or a touch mouse which launched in recent years.

However, to execute some specific functions, the user must touch the touch input device in a certain sequence, and then the touch input device has to detect more than two touch points to enable the function simultaneously. However, the above conventional touch input devices cannot meet this requirement.

Taking a shooting function in a game for example, a user first executes a first control action of aiming at a target, and then the user executes a second control action of shooting bullets simultaneously while aiming at the target. The first control action and the second control action have a certain sequence, and the user needs to hold the first control action while the second control action is executed. The shooting function can be enabled only when both the first control action and the second control action are detected.

When the shooting function is executed via a touch pad or a touch mouse, a first area of the touch pad or the touch mouse is touched to aim at a target, and then a second area is touched to trigger shooting function. In the meantime, the first area is touched while the second area is touched.

However, the conventional touch input devices can only identify the first control action. When the first control action is hold and a subsequent touch is provided, the subsequent touch would not be identified. Consequently, those touch input devices cannot meet the requirement of a simultaneous multi-key trigger function.

### BRIEF SUMMARY OF THE INVENTION

A multi-touch input method for a touch input device is provided. The multi-touch input method includes the following steps: defining a first touch area and a second touch area on a touch input device; generating a first control command when the first touch event is provided; detecting whether a second touch event is provided at the second touch area while the first touch event is kept for a period, generating a second control command when the second touch event is provided, and executing a corresponding function.

The first touch area and the second touch area of the conventional touch input devices can be regard as a left button and a right button of the conventional mouse in the disclosure.

When the first touch area is touched for a period and the second touch area is tapped, the touch input device can detect both the first touch area and the second touch area at the same time to execute a simultaneous multi-key trigger function.

### BRIEF DESCRIPTION OF THE DRAWINGS

FIG. 1 is a schematic diagram showing a touch input device in an embodiment;

FIG. 2 is a schematic diagram showing a touch input device in another embodiment;

FIG. 3 is a flowchart showing a multi-touch input method in an embodiment of the invention; and

FIG. 4 is a schematic diagram showing that a touch input device is operated by a multi-touch input method in an embodiment of the invention.

### DETAILED DESCRIPTION OF THE EMBODIMENTS

These and other features, aspects and advantages of the present invention will become better understood with regard to the following description, appended claims, and accompanying drawings.

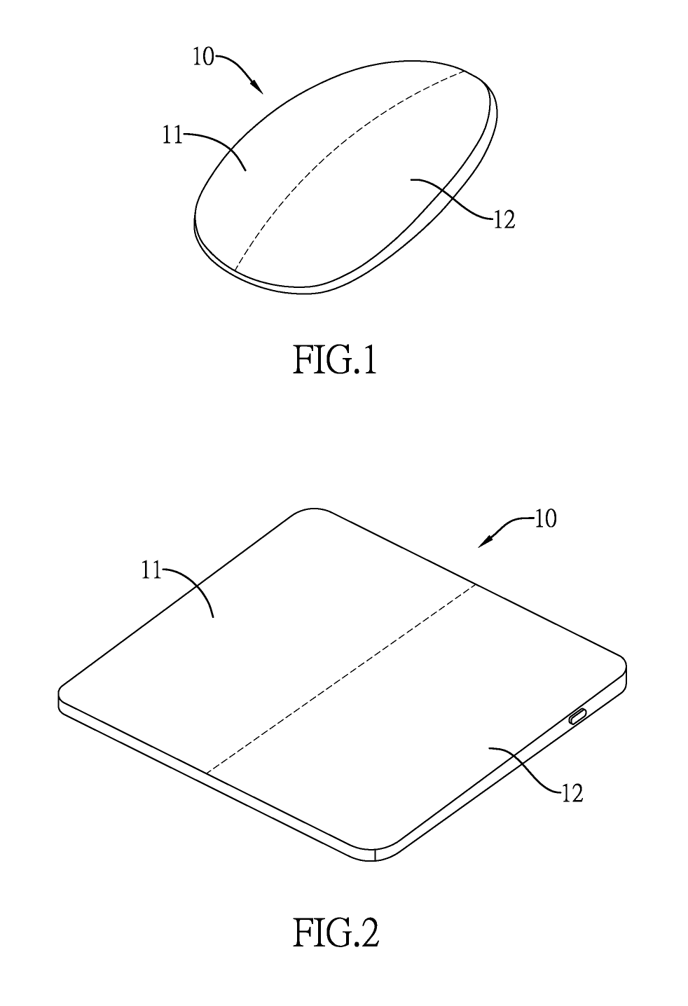

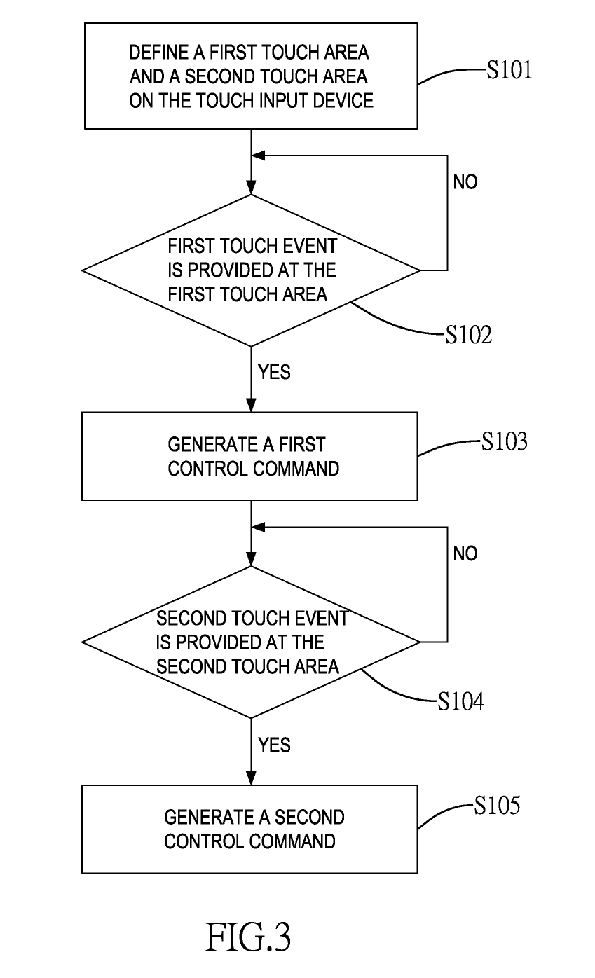

FIG. 1 and FIG. 2 are schematic diagrams showing a touch input device 10 in different embodiments, respectively. A touch pad and a touch mouse are taken as an example. The steps shown as FIG. 3 can be achieved via the touch input device 10. The multi-touch input method includes the following steps:

In step S101, defining a first touch area and a second touch area on a touch input device;

In step S102, detecting whether a first touch event is provided at the first touch area, In step S103, generating a first control command when the first touch event is provided;

In step S104, detecting whether a second touch event is provided at the second touch area while the first touch event is kept for a period. In step S104, generating a second control command when the second touch event is generated. In an embodiment, the second touch event is that an object taps on the second touch area, and a corresponding function is enabled when both the first control command and the second control command are generated.

In step S101, a first touch area 11 and a second touch area 12 are defined on a surface of the touch input device 10, or they are preferably defined according to a user's habit of operating the touch input device 10. In respect of a touch mouse, the surface can be divided into a left area and a right area to be regarded as the first touch area 11 and the second touch area 12 which represent a left key and a right key of the touch mouse, respectively. In respect of a touch pad, the whole surface can be divided into a left area and a right area to be regarded as the first touch area 11 and the second touch area 12, or the first touch area 11 and the second touch area 12 can be defined at a local region at which different fingers frequently touch.

In step S102, the touch input device 10 detects whether the first touch event is provided at the first touch area 11. For example, an object, such as a user's finger touches for a period on the first touch area 11, which can be regarded as the first touch event. As a result, the touch input device 10 outputs the first control command.

In step S104, the touch input device 10 detects whether the second touch event is provided at the second touch area 12 while the first touch event is provided. As stated above, taking the first touch as the first touch event, while the user's finger does not leave the surface of the first touch area 11 after touching the first touch area 11, another finger taps or touches on the second touch area 12 simultaneously, which can be regarded as the second touch event. As a result, the touch input device 10 outputs a second control command. When a touch on the first touch area 11 for a period is regarded as the first touch event, that is, while the user's finger touches for a period on the first touch area 11 and does not leave the surface of the first touch area 11, another finger taps once or twice on the second touch area 12, which can also be regarded as the second touch event. As a result, the touch input device 10 outputs the second control command.

Whether the user executes the tap action can be determined according to time interval and displacement between tapping on the second touch area. For example, after the user's finger touches on the surface of the second touch area 12, the finger leaves the surface immediately within a preset time (such as 125 ms), and the displacement between the position that the finger touches and the position that the finger leaves is less than a preset range (such as 2 mm), that is, the tap is executed.

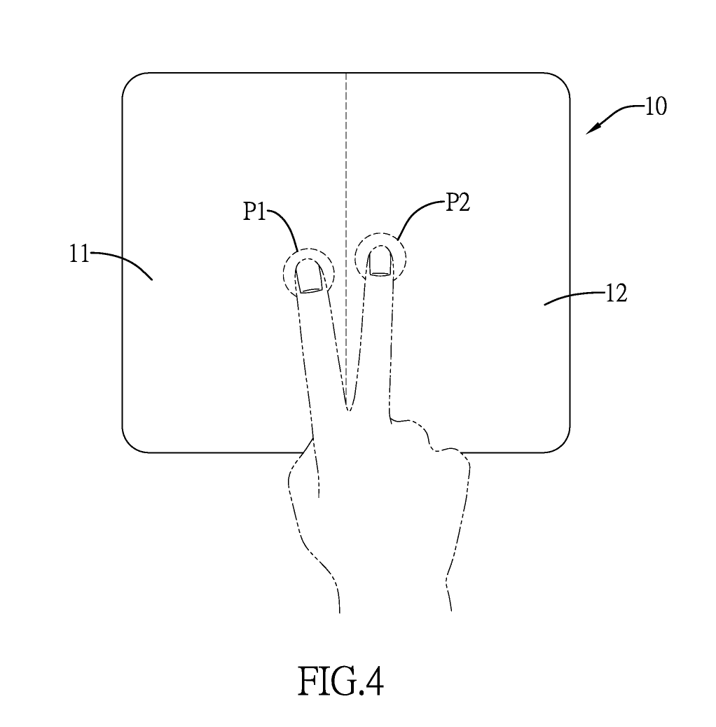

Please refer to FIG. 4. In step S102, when a touch is taken as the first touch event, whether a position of the first touch event is kept for a period at a fixed position P1 is determined by detecting whether a first touch event is provided at the first touch area 11. When the first touch event is provided at the first touch area 11, that is, the finger keeps touching (not dragging) after the user's finger touches on the first touch 11, and the first touch event is determined. Similarly, in step S104, whether a position of the second touch event is kept at a fixed position P2 is further determined. When the second touch event is provided at the second touch area 12, that is, while the user's finger touches on the second touch area 12, the finger keeps touching (not dragging), and the second touch event is determined.

In practice, when the touch input device 10 runs a game with a shooting function, a cursor is moved onto the target of the game screen, and the first touch area 11 is touched to generate the first control command to aim at the target. When the first touch area 11 is touched for a period, that is, the user executes a function of aiming at the target continuously. After aiming at the target, the first finger keeps on contacting with the first touch area 11, meanwhile, the user taps on the second touch area 12 by the second finger and leaves the second touch area 12, the second control command of shooting is generated.

Preferably, the first control command and the second control command are associated operation which are combined to generate a fully function, such as operations of “aiming the target” and “shooting”, which are combined to execute the preset shooting function.

In an embodiment, a zooming function is taken as an example. When the user wants to read a partial area of a document through the touch input device 10, a cursor is moved onto the partial area and the first touch area 11 is touched to generate a first control command of selecting a target area. When the first touch area 11 is touched for a period, and meanwhile the second touch area 12 is touched, then the second control command is generated to achieve the zooming function. The selected target area can be zoomed out or zoomed in according to a preset ratio (such as 200% and 50%).

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A multi-touch input method of a touch input device, comprising:
defining a first touch area and a second touch area on the touch input device;
generating a first control command when a first touch event is provided;
detecting whether a second touch event is provided at the second touch area while the first touch event is kept for a period, and
generating a second control command when the second touch event is provided; and
executing a corresponding function.

2. The multi-touch input method of the touch input device according to claim 1, wherein the first touch event is provided by touching on the first touch area for a period.

3. The multi-touch input method of the touch input device according to claim 1, wherein the second touch event is provided by tapping on the second touch area.

4. The multi-touch input method of the touch input device according to claim 1, wherein the second touch event is provided by tapping at least once on the second touch area.

5. The multi-touch input method of the touch input device according to claim 1, wherein when the first touch event is provided, determining whether the first touch event is provided in a fixed position; and when the second touch event is provided, determining whether the second touch event is provided in a fixed position.

6. The multi-touch input method of the touch input device according to claim 1, wherein the second touch event is identified according to time interval and displacement between tapping on the second touch area.

7. The multi-touch input method of the touch input device according to claim 1, wherein the touch input device is a touch mouse or a touch pad.

8. The multi-touch input method of the touch input device according to claim 1, wherein the corresponding function is a zooming function or an aim shooting function.
